(19) United States
(12) Patent Application Publication
(10) Pub. No.: US 2026/0172371 A1
(43) Pub. Date: Jun. 18, 2026

(54) NETWORK PACKET PROCESSING APPARATUS WITH MULTI-CORE PARALLEL PROCESSING CAPABILITY AND PACKET ORDER-PRESERVING CAPABILITY AND ASSOCIATED NETWORK PACKET PROCESSING METHOD

(71) Applicant: Airoha Technology (Suzhou) Limited, Suzhou City (CN)

(72) Inventors: Weihua Huang, Nanjing City (CN); Peng Du, Nanjing City (CN); Fei Yan, Nanjing City (CN)

(73) Assignee: Airoha Technology (Suzhou) Limited, Suzhou City (CN)

(21) Appl. No.: 19/373,740

(22) Filed: Oct. 30, 2025

(30) Foreign Application Priority Data
Dec. 16, 2024 (WO) PCT/CN2024/139645

(51) Int. Cl. H04L 49/102

(52) U.S. Cl. CPC H04L 49/102

(57) ABSTRACT

A network packet processing apparatus includes a receive (RX) ring buffer, a transmit (TX) ring buffer, and a plurality of first processor cores. The RX ring buffer includes a plurality of storage blocks, each arranged to buffer an RX packet descriptor of a network packet before the network packet is processed. The TX ring buffer includes a plurality of storage blocks, each arranged to buffer a TX packet descriptor of the network packet after the network packet is processed. The first processor cores retrieve RX packet descriptors of a plurality of network packets from the RX ring buffer in parallel, process the plurality of network packets in parallel, and write TX packet descriptors of the plurality of network packets into the TX ring buffer in parallel.

### BACKGROUND OF THE INVENTION

### 1. Field of the Invention

The present invention relates to network packet forwarding, and more particularly, to a network packet processing apparatus with multi-core parallel processing capability and packet order-preserving capability and an associated network packet processing method.

### 2. Description of the Prior Art

A gateway is a common network device used to connect different networks and forward packets from one network to another network, such as packet forwarding between a wired network and a wireless network. A network processing unit (NPU) is a high-speed programmable processor specially used for network packet processing (e.g., network packet forwarding). It has some features and architecture to accelerate the processing efficiency of network packets. However, as the network bandwidth continues to grow, network packets are transmitted at a higher rate, which requires the NPU to be able to quickly process these high-speed ingress network packets. One conventional solution may use a multi-core NPU. Multi-core parallel processing can effectively improve NPU's processing performance and forwarding throughput. However, due to the fact that different processor cores of the NPU may have different processing speeds of network packets, the multi-core parallel processing may cause network packets to be out of order. Thus, there is a need for an innovative design which can improve the network packet forwarding performance by leveraging the multi-core parallel processing technique, while still maintaining the order of network packets.

### SUMMARY OF THE INVENTION

One of the objectives of the claimed invention is to provide a network packet processing apparatus with multi-core parallel processing capability and packet order-preserving capability and an associated network packet processing method.

According to a first aspect of the present invention, an exemplary network packet processing apparatus is disclosed. The exemplary network packet processing apparatus includes a receive (RX) ring buffer, a transmit (TX) ring buffer, and a plurality of first processor cores. The RX ring buffer includes a plurality of storage blocks, each arranged to buffer an RX packet descriptor of a network packet before the network packet is processed. The TX ring buffer includes a plurality of storage blocks, each arranged to buffer a TX packet descriptor of the network packet after the network packet is processed. The plurality of first processor cores are arranged to retrieve RX packet descriptors of a plurality of network packets from the RX ring buffer in parallel, process the plurality of network packets in parallel, and write TX packet descriptors of the plurality of network packets into the TX ring buffer in parallel.

According to a second aspect of the present invention, an exemplary network packet processing method is disclosed. The exemplary network packet processing method includes: retrieving, by a plurality of first processor cores, receive (RX) packet descriptors of a plurality of network packets from an RX ring buffer in parallel, wherein the RX ring buffer includes a plurality of storage blocks, each arranged to buffer an RX packet descriptor of a network packet before the network packet is processed; processing, by the plurality of first processor cores, the plurality of network packets in parallel; and writing, by the plurality of first processor cores, transmit (TX) packet descriptors of the plurality of network packets into a TX ring buffer in parallel, wherein the TX ring buffer includes a plurality of storage blocks, each arranged to buffer a TX packet descriptor of the network packet after the network packet is processed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network packet processing apparatus according to an embodiment of the present invention.

FIG. 2 is a flowchart illustrating operations of a processing core according to an embodiment of the present invention.

FIG. 3 is a flowchart illustrating operations of an index updating core according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

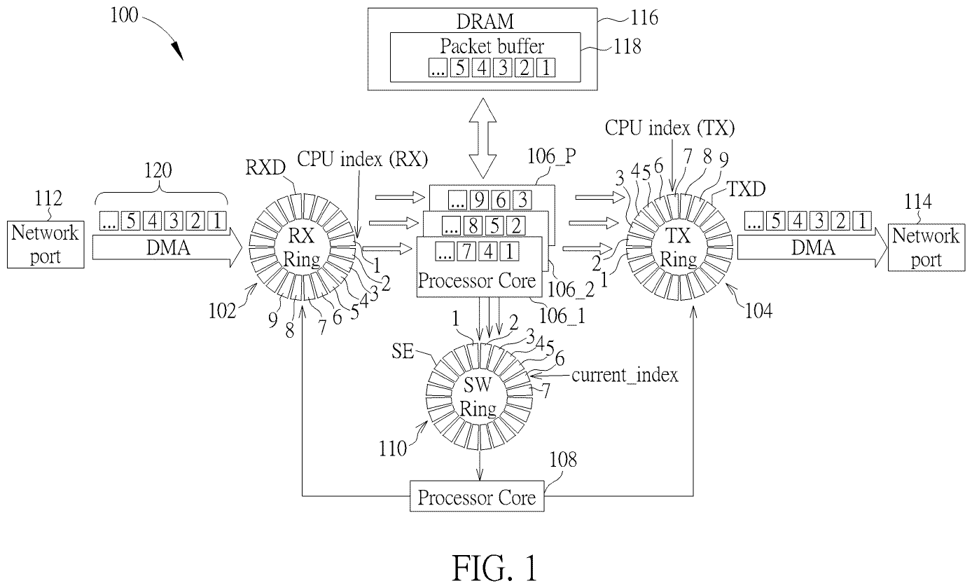

FIG. 1 is a diagram illustrating a network packet processing apparatus according to an embodiment of the present invention. For example, the network packet processing apparatus 100 may be employed by a network device such as a gateway. As shown in FIG. 1, the network packet processing apparatus 100 may include a receive (RX) ring buffer (labeled by “RX Ring”) 102, a transmit (TX) ring buffer (labeled by “TX Ring”) 104, a plurality of processor cores 106_1-106_P (P≥2) and 108, a software (SW) ring buffer (labeled by “SW Ring”) 110, a plurality of network ports 112, 114, and a dynamic random access memory (DRAM) 116. It should be noted that only the components pertinent to the present invention are illustrated in FIG. 1. In practice, the network packet processing apparatus 100 may include additional components to achieve designated functions.

The network packet processing apparatus 100 receives network packets 120 from the network port 112, and then a direct memory access (DMA) controller (not shown) copies and writes each of the network packets 120 into a packet buffer 118 that is allocated in the DRAM 116. When the packet buffer 118 is being initialized, the packet buffer 118 is divided into a plurality of storage blocks according to a fixed block size, where the storage blocks are used to store a plurality of network packets 120, respectively.

In this embodiment, the processor cores 106_1-106_P and 108 may be included in the same network processing unit (NPU), where processor cores 106_1-106_P may act as processing cores, and the processor core 108 may act as an index updating core. The RX ring buffer 102 and the TX ring buffer 104 may be allocated in a static random access memory (SRAM), but the present invention is not limited thereto. The RX ring buffer 102 is allocated for reception of network packets from the network port 112. The TX ring buffer 104 is allocated for transmission of network packets to be forwarded via the network port 114 under control of the DMA controller (not shown). Specifically, the RX ring buffer 102 is divided into a plurality of storage blocks, each arranged to buffer an RX packet descriptor RXD of a network packet before the network packet is processed, and the TX ring buffer 104 is divided into a plurality of storage blocks, each arranged to buffer a TX packet descriptor TXD of the network packet after the network packet is processed. Each packet descriptor may record some metadata of a corresponding network packet. For example, the packet descriptor may have a plurality of fields, including a field used to record a packet length pkt_len and a field used to record a memory location of a network packet stored in the packet buffer 118. Hence, a processor core refers to the metadata recorded in an RX packet descriptor to read information carried by a corresponding network packet stored in the packet buffer, and then perform certain packet processing to generate a processed network packet to be forwarded via the network port 114. After processing of the network packet to be forwarded is completed, the processor core stores a TX packet descriptor of the network packet to be forwarded into the TX ring buffer 104, and then the DMA controller can refer to the metadata recorded in the TX packet descriptor to read a corresponding network packet from the packet buffer 118 for packet forwarding.

In this embodiment, the processor cores 106_1-106_P are arranged to retrieve RX packet descriptors of a plurality of network packets from the RX ring buffer 102 in parallel, process the plurality of network packets in parallel, and write TX packet descriptors of the plurality of network packets into the TX ring buffer 104 in parallel. Hence, the network packet processing apparatus 100 can achieve improved processing performance and forwarding throughput by leveraging the multi-core parallel processing capability. Specifically, multi-core parallel processing is involved in writing TX packet descriptors into the TX ring buffer 104. In this embodiment, the multi-core parallel processing of writing TX packet descriptors into the TX ring buffer 104 can be performed under a condition that packet order-preserving is maintained. For example, each storage block of the RX ring buffer 102 is indexed by an RX index Rx index, and each storage block of the TX ring buffer 104 is indexed by a TX index TX index. The processor cores 106_1-106_P are further arranged to compute a plurality of RX indexes RX index and a plurality of TX indexes TX index according to predetermined rules (e.g., an RX-index determination algorithm A1 and a TX-index determination algorithm A2), where specific RX packet descriptors are retrieved from the RX ring buffer 102 according to the computed RX indexes RX index, respectively, the specific TX packet descriptors are written into the TX ring buffer 104 according to the computed TX indexes TX index, respectively, and an order of the specific TX packet descriptors buffered in the TX ring buffer 104 is identical to an order of the specific RX packet descriptors buffered in the RX ring buffer 102.

The number of processing cores (i.e., the number of processor cores 106_1-106_P) is P. Suppose that the size of the RX ring buffer 102 (i.e., the number of storage blocks allocated in the RX ring buffer 102) is N_{R}, and the size of the TX ring buffer 104 (i.e., the number of storage blocks allocated in the TX ring buffer 104) is N_{T}, where N_{R} is divisible by P, and N_{T} is also divisible by P. The core indexes i of multiple processing cores (i.e., processor cores 106_1-106_P) are from 0 to (P-1). For example, the first processor core 106_1 is denoted by Core 0, and the last processor core 106_P is denoted by Core (P-1). Regarding each Core i, one start-index parameter RX index 0 is set by the core index i (i.e., RX index 0=i), and another start-index parameter TX index 0 is also set by the core index i (i.e., TX index 0=i).

Each of the processor cores 106_1-106_P can obtain its RX index RX index by using the same RX-index determination algorithm A1. For example, the RX-index determination algorithm A1 may be expressed using the following pseudo code.

for (k1 = 0; ; k1=(k1+1)%(C_{R}/m))
for(r = 0; r < m; r++)
RX_index = k1*P*m + RX_index_0*m + r

An average of RX packet descriptors corresponding to one processor core is C_{R}

$$( {C}_{R} = \frac{{N}_{R}}{P} ) .$$

The parameter m defines the number of consecutive RX indexes assigned to one processor core, where C_{R} is divisible by m, and the parameter m is set by 1 by default. The variable k1 is set according to a sequence of

$$0 \to 1 \to 2 … \to ( \frac{{C}_{R}}{m} - 1 ) \to 0 \to 1 \to … .$$

A start RX index of Core i is set by RX index 0*m. Since the processor cores 106_1-106_P have different start RX indexes and the same RX-index determination algorithm A1 is used by all processor cores 106_1-106_P, the RX-index determination algorithm A1 defines a plurality of groups of RX indexes unique to the processor cores 106_1-106_P, respectively. Considering a case where P=6, N_{R}=12 and m=1, the RX-index determination algorithm A1 defines a unique group of RX indexes {0, 6} for Core 0, defines a unique group of RX indexes {1, 7} for Core 1, defines a unique group of RX indexes {2, 8} for Core 2, defines a unique group of RX indexes {3, 9} for Core 3, defines a unique group of RX indexes {4, 10} for Core 4, and defines a unique group of RX indexes {5, 11} for Core 5. Considering another case where P=6, N_{R}=12 and m=2, the RX-index determination algorithm A1 defines a unique group of RX indexes {0, 1} for Core 0, defines a unique group of RX indexes {2, 3} for Core 1, defines a unique group of RX indexes {4, 5} for Core 2, defines a unique group of RX indexes {6, 7} for Core 3, defines a group of RX indexes {8, 9} for Core 4, and defines a unique group of RX indexes {10, 11} for Core 5.

Each of the processor cores 106_1-106_P can obtain its TX index RX index by using the same TX-index determination algorithm A2. For example, the TX-index determination algorithm A2 may be expressed using the following pseudo code.

for (k2 = 0; ; k2=(k2+1)%(C_{T}/m))
for(r = 0; r < m; r++)
TX_index = k2*P*m + TX_index_0*m + r

An average of TX packet descriptors corresponding to one processor core is C_{T}

$$( {C}_{T} = \frac{{N}_{T}}{P} ) .$$

As mentioned above, the parameter m defines the number of consecutive RX indexes assigned to one processor core, where C_{T} is divisible by m, and the parameter m is set by 1 by default. The variable k2 is set according to a sequence of

$$0 \to 1 \to 2 … \to ( \frac{{C}_{T}}{m} - 1 ) \to 0 \to 1 \to … .$$

A start TX index of Core i is set by TX index 0*m. Since the processor cores 106_1-106_P have different start TX indexes and the same TX-index determination algorithm A2 is used by all processor cores 106_1-106_P, the TX-index determination algorithm A2 defines a plurality of groups of TX indexes unique to the processor cores 106_1-106_P, respectively. It should be noted that the size N_{R} of the RX ring buffer 102 is not necessarily the same as the size N_{T} of the TX ring buffer 104.

When the size N_{R} of the RX ring buffer 102 is equal to the size N_{T} of the TX ring buffer 104 (i.e., N_{R}=N_{T}), the TX-index determination algorithm A2 is the same as the RX-index determination algorithm A1. Considering a case where P=6, N_{T}=12 and m=1, the TX-index determination algorithm A2 defines a unique group of TX indexes {0, 6} for Core 0, defines a unique group of TX indexes {1, 7} for Core 1, defines a unique group of TX indexes {2, 8} for Core 2, defines a unique group of TX indexes {3, 9} for Core 3, defines a unique group of TX indexes {4, 10} for Core 4, and defines a unique group of TX indexes {5, 11} for Core 5. Considering another case where P=6, N_{T}=12 and m=2, the TX-index determination algorithm A2 defines a unique group of TX indexes {0, 1} for Core 0, defines a unique group of TX indexes {2, 3} for Core 1, defines a unique group of TX indexes {4, 5} for Core 2, defines a unique group of TX indexes {6, 7} for Core 3, defines a group of TX indexes {8, 9} for Core 4, and defines a unique group of TX indexes {10, 11} for Core 5.

When the size N_{R} of the RX ring buffer 102 is different from the size N_{T} of the TX ring buffer 104 (i.e., N_{R}#N_{T}), the TX-index determination algorithm A2 is different from the RX-index determination algorithm A1 due to

$$\frac{{C}_{T}}{m} \neq \frac{{C}_{R}}{m} .$$

Considering a case where P=6, N_{T}=24 and m=1, the TX-index determination algorithm A2 defines a unique group of TX indexes {0, 6, 12, 18} for Core 0, defines a unique group of TX indexes {1, 7, 13, 19} for Core 1, defines a unique group of TX indexes {2, 8, 14, 20} for Core 2, defines a unique group of TX indexes {3, 9, 15, 21} for Core 3, defines a unique group of TX indexes {4, 10, 16, 22} for Core 4, and defines a unique group of TX indexes {5, 11, 17, 23} for Core 5. Considering another case where P=6, N_{T}=24 and m=2, the TX-index determination algorithm A2 defines a unique group of TX indexes {0, 1, 12, 13} for Core 0, defines a unique group of TX indexes {2, 3, 14, 15} for Core 1, defines a unique group of TX indexes {4, 5, 16, 17} for Core 2, defines a unique group of TX indexes {6, 7, 18, 19} for Core 3, defines a group of TX indexes {8, 9, 20, 21} for Core 4, and defines a unique group of TX indexes {10, 11, 22, 23} for Core 5.

As mentioned above, the processor cores 106_1-106_P retrieve RX packet descriptors from the RX ring buffer 102, and write TX packet descriptors into the TX ring buffer 104. Hence, a utilization status of the RX ring buffer 102 should be reported for triggering the DMA controller (not shown) to receive new network packets. For example, new RX packet descriptors are added to the RX ring buffer 102 after old RX packet descriptors are consumed by the processor cores 106_1-106_P. Similarly, a utilization status of the TX ring buffer 104 should be reported for triggering the DMA controller (not shown) to send network packets. For example, old TX packet descriptors are consumed by the DMA controller (not shown) after new TX packet descriptors are added to the TX ring buffer 104. In this embodiment, the processor core 108 is arranged to update a CPU index (RX) which is indicative of a utilization status of the RX ring buffer 102, without intervention of the processor cores 106_1_106_P (which act as processing cores), and is further arranged to update a CPU index (TX) which is indicative of a utilization status of the TX ring buffer 104, without intervention of the processor cores 106_1_106_P (which act as processing cores). Since none of the processor cores 106_1_106_P is required to update RX ring buffer's CPU index and TX ring buffer's CPU index, the processing performance and forwarding throughput of the processor cores 106_1_106_P can be improved by offloading the task of updating RX ring buffer's CPU index and TX ring buffer's CPU index to the processor core 108 (which acts as an index updating core).

In this embodiment, the SW ring buffer 110 is accessible to the processor cores 106_1-106_P and 108 (e.g., NPU cores), and includes a plurality of storage blocks, each arranged to buffer a status element SE. Each of the processor cores 106_1-106_P is further arranged to update a specific status element in the SW ring buffer 110 after writing a TX packet descriptor of a specific network packet into the TX ring buffer 104, where the specific status element is associated with a specific RX index used by the processor core for retrieving an RX packet descriptor of the specific network packet and a specific TX index used by the processor core for writing the TX packet descriptor of the specific network packet. For example, the specific status element is buffered in a storage block of the SW ring buffer 110 that is indexed by one of the specific RX index and the specific TX index, and the other of the specific RX index and the specific TX index is recorded in the specific status element. In this embodiment, the specific status element is buffered in a storage block of the SW ring buffer 110 that is indexed by the specific RX index, and the specific TX index is recorded in the specific status element. However, this is for illustrative purposes only, and is not meant to be a limitation of the present invention. In practice, any means capable of informing the processor core 108 of indexes RX index and TX index used by any of the processor cores 106_1-106_N may be employed by the SW ring buffer 110.

Specifically, each status element SE may include two attributes “status” and “TX CPU Index”. The attribute “status” indicates whether the attribute “TX CPU Index” of the status element SE has been used by the processor core 108 to update an index next Tx index, where an updated value of the CPU index (TX) is derived from the index next Tx index. For example, when the attribute “status” is set by a first logic value (e.g., status element.status=0), it indicates that the attribute “TX CPU Index” of the status element SE is not yet used by the processor core 108 to update the index next Tx index; and when the attribute “status” is set by a second logic value (e.g., status element.status=1), it indicates that the attribute “TX CPU Index” of the status element SE has been used by the processor core 108 to update the index next Tx index. All status elements in the SW ring buffer 110 may be initialized by O's (i.e., status element.status=0 and status element. TX CPU Index=0). In addition, the processor core 108 is arranged to read a status element from a storage block of the SW ring buffer 110 that is indexed by the index current index. In a case where an initial value of the index current index is set by 0, checking status elements stored in the SW ring buffer 110 starts from a storage block indexed by current index=0.

In this embodiment, the size of the SW ring buffer 110 (i.e., the number of storage blocks allocated in the SW ring buffer 110) is N_{S} that is equal to the size N_{R} of the RX ring buffer 102 (i.e., N_{S}=N_{R}). The processor cores 106_1-106_P are arranged to update status elements in the SW ring buffer 110 in parallel, where the status elements are stored in storage blocks indexed by the RX indexes RX index set by the RX-index determination algorithm A1.

The processor core 108 is arranged to check status element(s) in the SW ring buffer 110 for updating the CPU index (RX) and the CPU index (TX). In this embodiment, the processor core 108 does not determine whether to update the CPU index (RX) and the CPU index (TX) unless a counter value indicative of a number of times the processor core 108 checks one status element in the SW ring buffer 110 reaches a predetermined threshold. In this embodiment, the predetermined threshold is not smaller than two. Hence, the processor core 108 is designed to update the CPU index (RX) and the CPU index (TX) in a batch processing manner. This can reduce the CPU index updating frequency and the resource consumption, thereby improving the overall system efficiency and preventing the processor core 108 from becoming a bottleneck.

In addition, the processor core 108 does not read a status element stored in a next storage block of the SW ring buffer 110 unless a status element stored in a current storage block of the SW ring buffer 110 is read and used by the processor core 108 to update indexes next RX index and next TX index, where an updated value of the CPU index (RX) is derived from the index next RX index, and an updated value of the CPU index (TX) is derived from the index next TX index.

Further details of the processor cores 106_1-106_N (which act as processing cores) and the processor core 108 (which acts as an index updating core) are described as below.

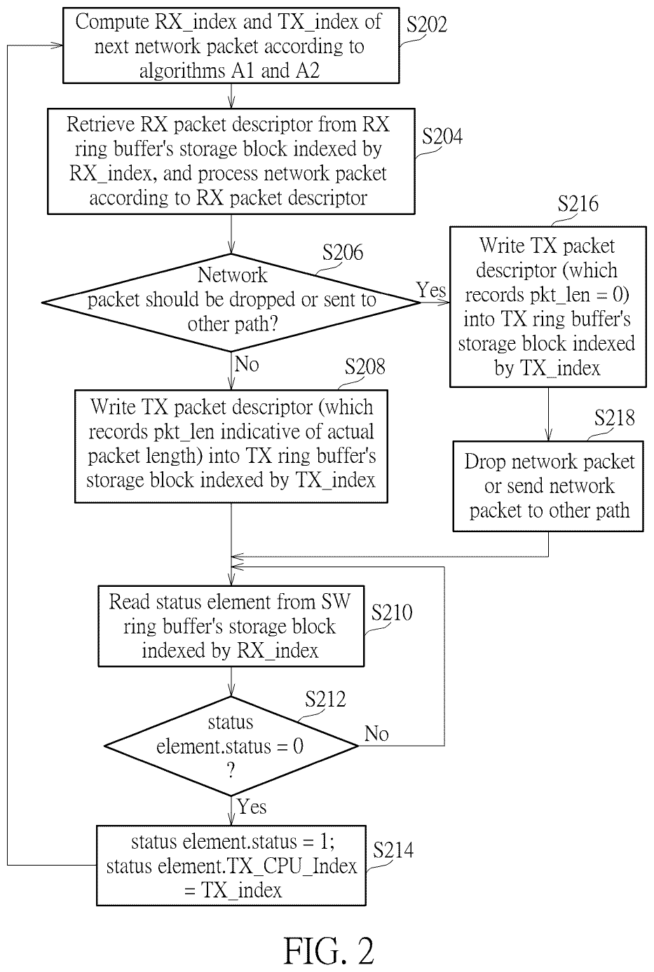

FIG. 2 is a flowchart illustrating operations of a processing core according to an embodiment of the present invention. The method shown in FIG. 2 may be employed by any of the processor cores 106_1-106_N included in the network packet processing apparatus 100 shown in FIG. 1. Provided that the result is substantially the same, the steps are not required to be executed in the exact order shown in FIG. 2. At step S202, the processing core computes indexes RX index and TX index for a next network packet according to the RX-index determination algorithm A1 and the TX-index determination algorithm A2. At step S204, the processing core retrieves an RX packet descriptor from a storage block of the RX ring buffer 102 that is indexed by the index RX index obtained at step S202, and processes a corresponding network packet in the packet buffer 118 according to the RX packet descriptor retrieved from the RX ring buffer 102.

At step S206, the processing core determines if the network packet should be dropped or sent to other path. If the network packet should be dropped or sent to other path, the flow proceeds to step S216. At step S216, the processing core writes a TX packet descriptor (which records pkt_len=0) into a storage block of the TX ring buffer 104 that is indexed by the index TX index obtained at step S202. At step S218, the network packet is dropped or sent to other path. If step S206 determines that the network packet should not be dropped or sent to other path, the flow proceeds to step S208. At step S208, the processing core writes a TX packet descriptor (which records pkt_len indicative of an actual packet length of the processed network packet) into a storage block of the TX ring buffer 104 that is indexed by the index TX index obtained at step S202. At step S210, the processing core reads a status element from a storage block of the SW ring buffer 110 that is indexed by the index RX index obtained at step S202. At step S212, the processing core checks the attribute “status” of the status element obtained at step S210. If the attribute “status” of the status element is set by a second logic value “1” (i.e., status element.status=1), it implies that the status element cannot be used by the processing core at this moment. Hence, the processing core keeps checking the attribute “status” of the same status element stored in a storage block indexed by the index RX index obtained at step S202. If step S212 determines that the attribute “status” of the status element is set by a first logic value “0” (i.e., status element.status=0), the flow proceeds to step S214. At step S214, the processing core updates the attribute “status” of the status element by the second logic value “1” (i.e., status element.status=1), and updates the attribute “TX CPU Index” of the status element by the index TX index obtained at step S202.

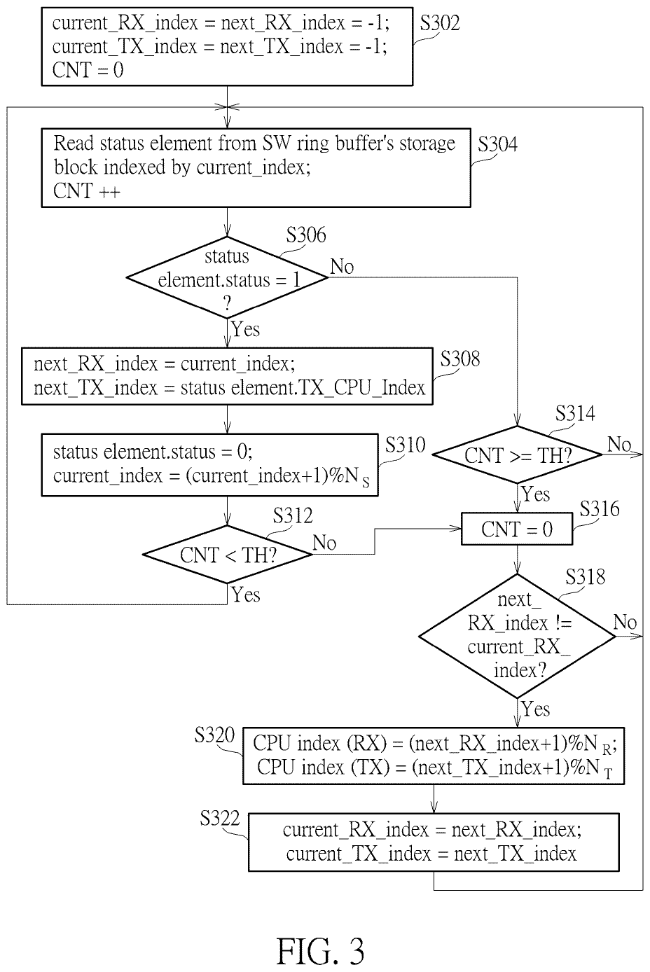

FIG. 3 is a flowchart illustrating operations of an index updating core according to an embodiment of the present invention. The method shown in FIG. 3 may be employed by the processor core 108 included in the network packet processing apparatus 100 shown in FIG. 1. Provided that the result is substantially the same, the steps are not required to be executed in the exact order shown in FIG. 3. At step S302, the index updating core initializes each of indexes current RX index, next_RX_index, current TX index, and next RX index by a predefined value (e.g., −1), and initializes a counter value CNT by a predefined value (e.g., 0). The counter value CNT is indicative of the number of time the index updating core reads one status element stored in the SW ring buffer 110. At step S304, the index updating core reads a status element from a storage block of the SW ring buffer 110 that is indexed by the index current index, and updates the counter value CNT by adding an increment value (e.g., 1) to the counter value CNT (i.e., CNT=CNT+1). At step S306, the index updating core checks if the attribute “status” of the status element is set by a second logic value “1” (i.e., status element.status=1). If the attribute “status” of the status element is set by the second logic value “1”, the flow proceeds to step S308. At step S308, the index updating core updates the index next RX index by the index current index, and updates the index next TX index by the attribute “TX CPU Index” of the status element. At step S310, the index updating core clears the attribute “status” of the status element by assigning the first logic value “0” to the attribute “status” of the status element, and changes the index current index to point to a next storage block in the SW ring buffer 110 (i.e., current index=(current index+1) % N_{S}). At step S312, the index updating core checks if the counter value CNT reaches a predetermined threshold TH (e.g., TH≥2). It should be noted that the predetermined threshold TH is programmable, and can be adjusted depending upon actual design considerations. Specifically, the predetermined threshold TH is a batch processing parameter. If the counter value CNT does not reach the predetermined threshold TH yet, the flow proceeds to step S304. If the counter value CNT reaches the predetermined threshold TH, the flow proceeds to step S316.

If step S306 determines that the attribute “status” of the status element is set by the first logic value “0”, the flow proceeds to step S314. If step S314 determines that the counter value CNT reaches the predetermined threshold TH, the flow proceeds to step S316. If step S314 determines that the counter value CNT does not reach the predetermined threshold TH yet, the flow proceeds to step S304.

At step S316, the index updating core resets the counter value CNT to an initial value (e.g., CNT=0). At step S318, the index updating core checks if the index next RX index is different from the index current RX index. If the index next RX index is equal to the index current RX index, it implies that no status element with status=1 is obtained from a storage block of the SW ring buffer 110 that is indexed by the index current index. Hence, the flow proceeds to step S304 to keep reading the same status element from a storage block of the SW ring buffer 110 that is indexed by the index current index.

If the index next RX index is different from (e.g., larger than) the index current RX index, it implies that at least status element with status=1 has been obtained from at least one storage block of the SW ring buffer 110 that is indexed by the index current index. Hence, the flow proceeds to step S320. At step S320, the index updating core updates the CPU index (RX) according to the index next RX index (e.g., CPU index (RX)=(next RX index) % N_{R}), and updates the CPU index (TX) according to the index next TX index (e.g., CPU index (TX)=(next TX index) % N_{T}). At step S322, the index updating core resets the index current RX index by the index next RX index (i.e., current RX index=next RX index), and resets the index current TX index by the index next TX index (i.e., current TX index next_TX_index). After indexes current RX index and current TX index are reset, the flow proceeds to step S304 to check a next status element stored in a storage block of the SW ring buffer 110 that is indexed by the index current index that is previously updated at step S310.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network packet processing apparatus comprising:
a receive (RX) ring buffer, comprising a plurality of storage blocks, each arranged to buffer an RX packet descriptor of a network packet before the network packet is processed;
a transmit (TX) ring buffer, comprising a plurality of storage blocks, each arranged to buffer a TX packet descriptor of the network packet after the network packet is processed; and
a plurality of first processor cores, arranged to retrieve RX packet descriptors of a plurality of network packets from the RX ring buffer in parallel, process the plurality of network packets in parallel, and write TX packet descriptors of the plurality of network packets into the TX ring buffer in parallel.

2. The network packet processing apparatus of claim 1, wherein each storage block of the RX ring buffer is indexed by an RX index; each storage block of the TX ring buffer is indexed by a TX index; the plurality of first processor cores are further arranged to compute a plurality of RX indexes and a plurality of TX indexes according to predetermined rules, where the RX packet descriptors are retrieved from the RX ring buffer according to the plurality of RX indexes, respectively, the TX packet descriptors are written into the TX ring buffer according to the plurality of TX indexes, respectively, and an order of the TX packet descriptors buffered in the TX ring buffer is identical to an order of the RX packet descriptors buffered in the RX ring buffer.

3. The network packet processing apparatus of claim 2, wherein the predetermined rules define a plurality of groups of RX indexes unique to the plurality of first processor cores, respectively, and define a plurality of groups of TX indexes unique to the plurality of first processor cores, respectively.

4. The network packet processing apparatus of claim 1, further comprising:
a second processor core, arranged to update a first index indicative of a utilization status of the RX ring buffer and update a second index indicative of a utilization status of the TX ring buffer, without intervention of the plurality of first processor cores.

5. The network packet processing apparatus of claim 4, further comprising:
a software (SW) ring buffer, comprising a plurality of storage blocks, each arranged to buffer a status element;
wherein each of the plurality of first processor cores is further arranged to update a specific status element in the SW ring buffer after writing a TX packet descriptor of a specific network packet into the TX ring buffer, where the specific status element is associated with a specific RX index used by said each of the plurality of first processor cores for retrieving an RX packet descriptor of the specific network packet and a specific TX index used by said each of the plurality of first processor cores for writing the TX packet descriptor of the specific network packet;
and the second processor core is further arranged to check at least one status element in the SW ring buffer for updating the first index and the second index.

6. The network packet processing apparatus of claim 5, wherein the specific status element is buffered in a storage block of the SW ring buffer that is indexed by one of the specific RX index and the specific TX index, and another of the specific RX index and the specific TX index is recorded in the specific status element.

7. The network packet processing apparatus of claim 5, wherein the second processor core does not determine whether to update the first index and the second index unless a counter value indicative of a number of times the second processor core checks one status element in the SW ring buffer reaches a predetermined threshold, where the predetermined threshold is not smaller than two.

8. The network packet processing apparatus of claim 5, wherein the second processor core does not read a status element stored in a next storage block of the SW ring buffer unless a status element stored in a current storage block of the SW ring buffer is read and used by the second processor core to update a third index and a fourth index, where an updated value of the first index is derived from the third index, and an updated value of the second index is derived from the fourth index.

9. The network packet processing apparatus of claim 5, wherein the plurality of first processor cores are arranged to update status elements in the SW ring buffer in parallel.

10. The network packet processing apparatus of claim 1, wherein the plurality of first processor cores are included in a same multi-core network processing unit (NPU).

11. A network packet processing method comprising:
retrieving, by a plurality of first processor cores, receive (RX) packet descriptors of a plurality of network packets from an RX ring buffer in parallel, wherein the RX ring buffer comprises a plurality of storage blocks, each arranged to buffer an RX packet descriptor of a network packet before the network packet is processed;
processing, by the plurality of first processor cores, the plurality of network packets in parallel; and
writing, by the plurality of first processor cores, transmit (TX) packet descriptors of the plurality of network packets into a TX ring buffer in parallel, wherein the TX ring buffer comprises a plurality of storage blocks, each arranged to buffer a TX packet descriptor of the network packet after the network packet is processed.

12. The network packet processing method of claim 11, wherein each storage block of the RX ring buffer is indexed by an RX index; each storage block of the TX ring buffer is indexed by a TX index; and the network packet processing method further comprises:
computing a plurality of RX indexes and a plurality of TX indexes according to predetermined rules, where the RX packet descriptors are retrieved from the RX ring buffer according to the plurality of RX indexes, respectively, the TX packet descriptors are written into the TX ring buffer according to the plurality of TX indexes, respectively, and an order of the TX packet descriptors buffered in the TX ring buffer is identical to an order of the RX packet descriptors buffered in the RX ring buffer.

13. The network packet processing method of claim 12, wherein the predetermined rules define a plurality of groups of RX indexes unique to the plurality of first processor cores, respectively, and define a plurality of groups of TX indexes unique to the plurality of first processor cores, respectively.

14. The network packet processing method of claim 11, further comprising:
updating, by a second processor core, a first index indicative of a utilization status of the RX ring buffer, without intervention of the plurality of first processor cores; and
updating, by the second processor core, a second index indicative of a utilization status of the TX ring buffer, without intervention of the plurality of first processor cores.

15. The network packet processing method of claim 14, further comprising:
updating, by each of the plurality of first processor cores, a specific status element in a software (SW) ring buffer after writing a TX packet descriptor of a specific network packet into the TX ring buffer;
wherein the SW ring buffer comprises a plurality of storage blocks, each arranged to buffer a status element; the specific status element is associated with a specific RX index used by said each of the plurality of first processor cores for retrieving an RX packet descriptor of the specific network packet and a specific TX index used by said each of the plurality of first processor cores for writing the TX packet descriptor of the specific network packet; and at least one status element in the SW ring buffer is checked for updating the first index and the second index.

16. The network packet processing method of claim 15, wherein the specific status element is buffered in a storage block of the SW ring buffer that is indexed by one of the specific RX index and the specific TX index, and another of the specific RX index and the specific TX index is recorded in the specific status element.

17. The network packet processing method of claim 15, further comprising:
not determining whether to update the first index and the second index unless a counter value indicative of a number of times one status element in the SW ring buffer is checked reaches a predetermined threshold, where the predetermined threshold is not smaller than two.

18. The network packet processing method of claim 15, further comprising:
not reading a status element stored in a next storage block of the SW ring buffer unless a status element stored in a current storage block of the SW ring buffer is read and used to update a third index and a fourth index, where an updated value of the first index is derived from the third index, and an updated value of the second index is derived from the fourth index.

19. The network packet processing method of claim 15, further comprising:
updating, by the plurality of first processor cores, status elements in the SW ring buffer in parallel.

20. The network packet processing method of claim 11, wherein the plurality of first processor cores are included in a same multi-core network processing unit (NPU).
